(19) United States
(12) Patent Application Publication
(10) Pub. No.: US 2008/0205894 A1
(43) Pub. Date: Aug. 28, 2008

(54) OPTICAL MODULE FOR OPTICALLY COUPLING OPTICAL FIBER AND SURFACE OPTICAL DEVICE

(75) Inventor: Shigenori AOKI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/038,428

(22) Filed: Feb. 27, 2008

(30) Foreign Application Priority Data
Feb. 27, 2007 (JP) 2007-047573

(51) Int. Cl. H04B 10/00

(52) U.S. Cl. 398/135

(57) ABSTRACT

An optical module including a first optical device having an opening on a surface thereof, and a second optical device including a pillar-shaped elastic member on a surface thereof. The first and second optical devices are optically coupled to each other.

### CROSS-REFERENCE TO RELATED APPLICATIONS

This application is based upon and claims the benefit of priority from the prior Japanese Patent Application No. 2007-47573, filed on Feb. 27, 2007, the entire contents of which are incorporated herein by reference.

### TECHNICAL FIELD

The present invention relates to an optical module that includes a surface optical device and that is usable for a multichannel optical tranceiver (for example, wavelength multiplex multichannel optical tranceiver), and a method of manufacturing the optical module.

### BACKGROUND OF THE INVENTION

In the case a surface optical device, such as a surface optical laser or photodiode, is used in an optical module, such as a multichannel optical tranceiver, a light incident surface (light receiving surface) or light output surface (light emitting surface) of the surface optical device is parallel to a mounting base board. Therefore, in such an optical module, light is directed to be incident to or emitted perpendicularly to the mounting base substrate.

In addition, such an optical module is required to accomplish miniaturization or thinness.

In order to accomplish miniaturization or thinness, an optical fiber (optical fiber array) is disposed parallel to the mounting substrate. In this case, an edge face of the optical fiber and the light incident surface or light output surface of the surface optical device have to be aligned face to face.

For this reason, the configuration has to be built in such a manner that a path (optical path) of light perpendicularly incident or output with respect to the light incident or output surface of the surface optical device mounted on the substrate is turned about 90 degrees to thereby optically couple between the optical fiber and the surface optical device.

As such, a technique has been proposed in which an optical waveguide structure including an optical waveguide (curvilinear waveguide) on a curved surface, whereby light incident or output on a surface optical device is guided along the curved surface to couple to an optical fiber array. For example, refer to the FIGS. 27 and 28 of U.S. Published Patent Application No. 2005/0058399 A1. This publication discloses a technique in which, in the configuration briefed as above, the optical path is sharply turned in a narrow spacing in an apparatus such as, for example, an optical transceiver.

In the field of optical modules such as described above, there are given rise to issues of achieving stability and cost reduction for portions optically coupled between the surface optical device and the optical fiber (optical fiber array). Note that a surface optical device such as described herein includes also a surface optical device array. Actual practical examples of surface optical device arrays include a VCSEL (vertical-cavity surface emitting laser) array and a PD (photodetector) array. A portion optically coupling such a surface optical device and optical fiber is called “optical coupling portion”.

U.S. Published Patent Application No. 2005/0058399 A1 discloses that the optical waveguide structure is used to optically couple between the surface optical device and the optical fiber. The surface optical device and the optical fiber are disposed apart at spacing from each other. According to the disclosure, light propagating through the spacing, that is, between the surface optical device and the optical waveguide structure is optically coupled by using, for example, a lens.

Nevertheless, however, even in the technique, which is disclosed in the U.S. Published Patent Application No. 2005/0058399 A1, there still remains a problem that it is difficult to align the surface optical device and the optical waveguide structure with each other. In particular, in a configuration using a surface optical device array including a plurality of surface optical devices, the plurality of surface optical devices and a plurality of optical waveguides have to be optically coupled to one another, and thus, alignment thereof encounters an even greater degree of difficulty. Further, in a configuration including a plurality of surface optical device arrays, such as surface light receiving device arrays and surface light emitting device arrays, the optical waveguide structure is disposed after the plurality of surface optical device arrays are disposed on the substrate and are then aligned therewith. In this case, since an optimal position of the optical waveguide structure does not match the respective surface optical device arrays, the alignment encounters a significant degree of difficulty.

Thus, according to the related art described above, inter-optical device alignment is not easy, and hence misalignment caused in a mounting or like event gives rise to unstable performance.

### SUMMARY OF THE INVENTION

According to one aspect of the present invention, an optical module comprises a first optical device including an opening on a surface thereof, and a second optical device including a pillar-shaped elastic member on a surface thereof. And the first and second optical devices are optically coupled to each other.

### BRIEF DESCRIPTION OF THE DRAWINGS

FIGS. 1A and 1B, respectively, are schematic views for explaining problems to be solved by the present invention;

FIG. 2 is a schematic cross sectional view showing the configuration of a major portion of an optical module according to one embodiment of the invention;

FIG. 3 is a schematic cross sectional view showing a modified example of openings of a waveguide array constituting the optical module according to one embodiment of the invention;

FIG. 4 is a schematic perspective view showing the overall configuration of the optical module according to one embodiment of the invention;

FIGS. 5A to 5C are schematic views for explaining the configurations of a PD array and pillars constituting the optical module and a forming method therefor in accordance with one embodiment of the invention; and

FIG. 6 is a schematic view showing the configuration of a waveguide array constituting an optical module in accordance with an embodiment of the invention; and

FIGS. 7A and 7B, respectively, are schematic views for explaining a method of manufacturing the optical module in accordance with the embodiment of the invention.

### DETAILED DESCRIPTION OF THE PREFERRED EMBODIMENTS

In addition to the above described, a case can occur in which misalignment is introduced due to thermal expansion or the like even after mounting of components such as a surface optical device (surface optical device array) and an optical waveguide structure (waveguide array). More specifically, generally, because the surface optical device and the optical waveguide structure are different from each other in thermal expansion coefficient, even when the devices have been mounted, misalignment can be introduced therebetween due to temperature variations. When misalignment is introduced between the surface optical device and the optical waveguide structure, the optical axis is offset, thereby causing the performance to be unstable. This is conspicuous particularly in the case the optical waveguide structure is formed using a polymer having a high thermal expansion coefficient.

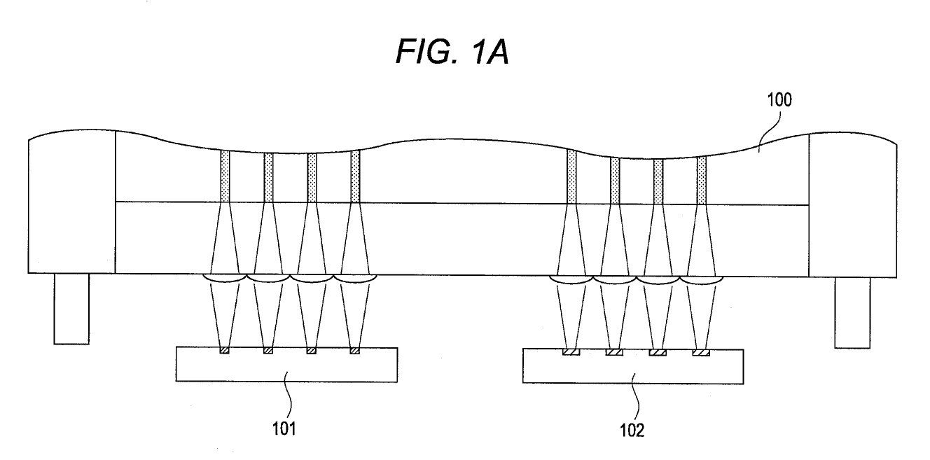

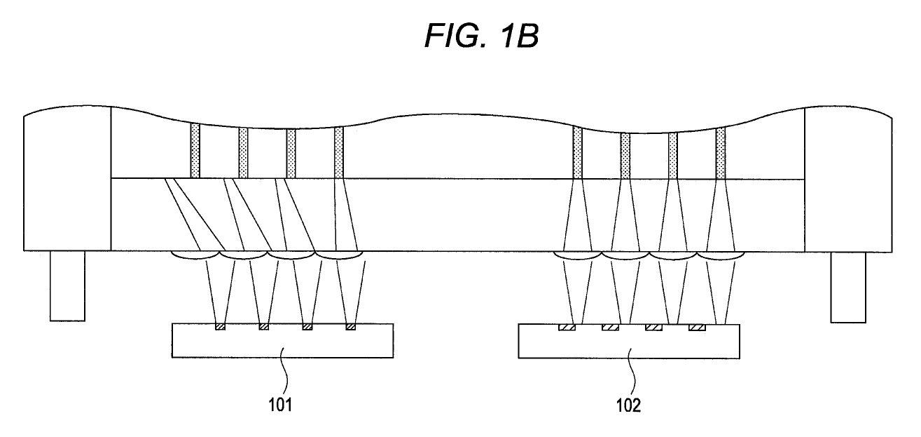

For example, suppose that a waveguide array 100 has a thermal expansion coefficient higher than, for example, a VCSEL array 101. In this case, as shown in FIG. 1A, even when the waveguide array 100, the VCSEL array 101, and the PD array 102 are accurately aligned in the mounting event (low temperature event), misalignment is introduced due to thermal expansion between the waveguide array 100 and the VCSEL array 101 in an operating event (high temperature event) as shown in FIG. 1B. Thereby, depending on the case, the optical axis is offset, and hence the performance becomes unstable.

Embodiments capable of solving problems including those described above will be described below.

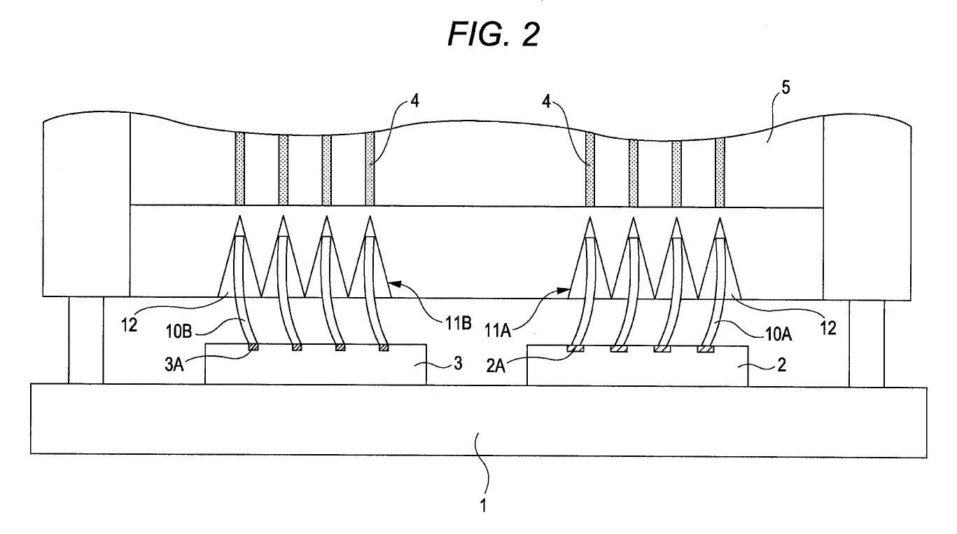

With reference to FIGS. 2 to 4, the following describes an optical module and a manufacturing method therefor in accordance with one embodiment of the present invention.

The optical module of the present embodiment is a multichannel optical tranceiver including a function (optical transmitter) that coverts an input electric signal to an optical signal to thereby transmit the converted optical signal through arrayed optical fibers. The optical tranceiver further includes a function (optical receiver) that converts an optical signal, that is input through the arrayed optical fibers, to an electric signal to thereby receive the converted signal.

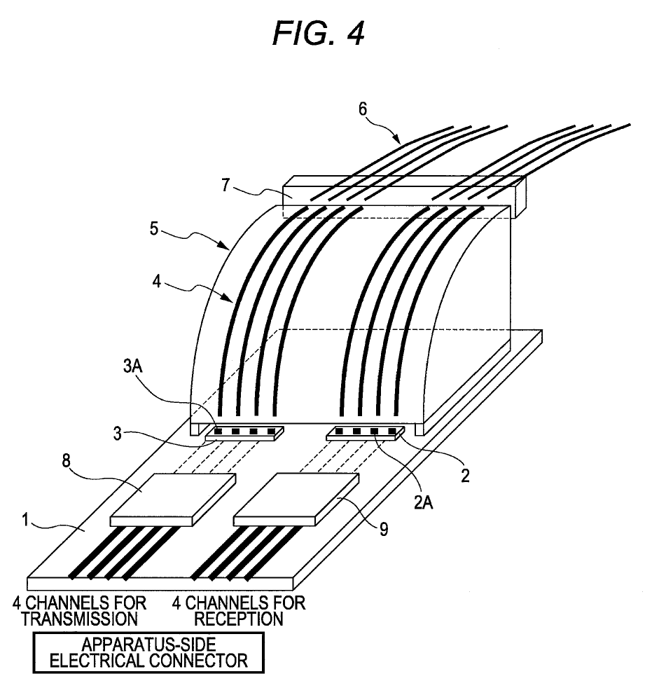

With reference to FIG. 4, the multichannel optical tranceiver includes, for example, a printed circuit board 1, a surface light receiving device array (PD array chip; or “second optical device” in the appended claims) 2, and a surface light emitting device array (VCSEL array chip; or “second optical device” in the appended claims) 3. The surface light receiving device array 2 includes a plurality of surface light receiving devices 2A. In the present example, photodetector (PD) comprises a photodiode. The surface light emitting device array 3 includes a plurality of surface light emitting devices 3A (in the present example, VCSELs (vertical-cavity surface emitting lasers)). The multichannel optical tranceiver further includes a waveguide array (waveguide block; or “optical waveguide device” in the appended claims) 5, a driver IC 8 (IC: integrated circuit), and a receiver IC 9. The waveguide array 5 includes a plurality of curvilinear waveguides 4. In the description hereinbelow, either the surface light receiving device 2A or the surface light emitting device 3A will be simply referred to as “surface optical device”, depending on the case. Further, in the present example, the multichannel optical tranceiver is exemplified as an optical tranceiver with four transmission channels (on a transmitting side) and four receiving channels (on a reception side).

With reference to FIG. 4, the surface light receiving device array 2 and the surface light emitting device array 3 are mounted in the manner that the plurality of surface light receiving devices 2A and the plurality of surface light emitting devices 3A are linearly aligned with one another on the printed circuit board 1.

Thus, the shown configuration includes one surface light receiving device array 2 and one surface light emitting device array 3. That is, the configuration is formed to include the plurality of surface optical devices. However, the configuration may be formed to function as a multichannel optical receiver including only one of the surface light receiving device array 2 and the surface light emitting device array 3. Still alternatively, the configuration may be formed to function as a multichannel optical transmitter including only one surface light emitting device array 3. Still alternatively, the configuration may be formed to function as an optical tranceiver including one surface light receiving device 2A and one surface light emitting device 3A. Still alternatively, the configuration may be formed to function as an optical module, such as either an optical receiver including only one surface light receiving device 2A or an optical transmitter including only one surface light emitting device 3A. In this configuration, the waveguide array 5 can be formed such that one curvilinear waveguide is formed on a plane.

In the configuration shown in FIG. 4, the waveguide array 5 is mounted via one end thereof on the printed circuit board 1. The other end of the waveguide array 5, which end is perpendicular to one end thereof, is optically coupled to an optical fiber array (ribbon fiber) 6 including a plurality of optical fibers. In the present example, the optical fiber array (ribbon fiber) 6 with an optical connector 7 is used.

As shown in FIG. 4, in the present example, the waveguide array 5 is configured in the form of an optical waveguide structure that includes the plurality of channel-shaped optical waveguides 4 (curvilinear waveguides). However, the configuration of the waveguide array 5 is not limited the configuration described above. For example, the configuration may be of the type described in Japanese Patent Application Laid-Open No. 2007-264033 (US Patent Application Publication No. 2007/0237449).

As shown in FIG. 4, the printed circuit board 1 is electrically connected to an external device via an apparatus-side electrical connector, in which an electric signal is input or output (electrically input/output).

According to the present embodiment, as shown in FIG. 2, the PD array 2 includes a plurality of optical resin pillars 10A on a surface (light receiving surface) of the PD array 2. Similarly, the VCSEL array 3 includes a plurality of optical resin pillars 10B on a surface (light emitting surface) of the VCSEL array 3.

In the present example, the optical resin pillars 10A and 10B are formed from a photoconductive optical resin material (transparent resin material). Since the optical resin pillars 10A and 10B are thus formed from the transparent resin material, the optical resin pillars 10A and 10B are alternatively referred to as “transparent resin pillars”. In the present example, the example using the transparent resin material as a material for forming the optical resin pillars 10A and 10B, but the material is not limited thereto. Thus, the optical resin pillars 10A and 10B to be formed on the respective surfaces of the PD array 2 and the VCSEL array 3 are either pillar-shaped transparent elastic members or pillar-shaped elastic members of which examples include pillar-shaped optical elastic members.

The cross-sectional area size of the respective optical resin pillars 10A, 10B is determined corresponding to the size of an active area (the active area is in the light receiving surface or in the light emitting surface) of the respective surface light receiving device 2A and surface light emitting device 3A. For example, the cross-sectional area size of the respective optical resin pillar 10A, which is formed on the light receiving surface of the PD 2A (surface light receiving device 2A), can be determined to be smaller than or equal to the area size of the light receiving surface of the PD 2A. In addition, the cross-sectional area size of the optical resin pillar 10B, which is formed on the light emitting surface of the VCSEL 3A (surface light emitting device 3A), can be determined to be larger than the area size of the light emitting surface of the VCSEL 3A.

The length of the optical resin pillars 10A, 10B may be arbitrarily determined. For example, the length of the optical resin pillars 10A, 10B may be approximately identical to the distance to the end portion of the optical waveguide 4 of the waveguide array 5 from the surface of the surface optical device array 2, 3 (the light receiving or emitting surface of each surface optical device 2A, 3A) in the state the surface optical device array 2, 3 and the waveguide array 5 are mounted on the printed circuit board 1.

As shown in FIG. 2, the waveguide array 5 includes pluralities of openings 11A and 11B on the surface (edge face on the side opposing the printed circuit board 1 in the mounting event) of the waveguide array 5. More specifically, the respective openings 11A, 11B each are provided on an extended line of the optical waveguide 4 and in the vicinity of the end portion of the optical waveguide 4. The respective openings 11A, 11B each have a tapered shape (such that tapered opening) formed such that the area size of the opening is smaller towards the depth portion. As shown in FIG. 2, a leading edge of the respective tapered openings exists in a position spaced apart by a predetermined distance from the end portion of the optical waveguide 4. That is, the respective openings 11A, 11B are inwardly tapered to be gradually increased in the cross-sectional area size towards the edge face of the waveguide array 5 from the position spaced apart by the predetermined distance from the end portion of the optical waveguide 4. In the present example, the respective optical waveguides 4 and the respective openings 11A, 11B are thus formed to be spaced apart by the predetermined distance from one another. However, the configuration is not limited thereto, but may be such that the respective optical waveguides 4 and the respective openings 11A, 11B are coupled to one another.

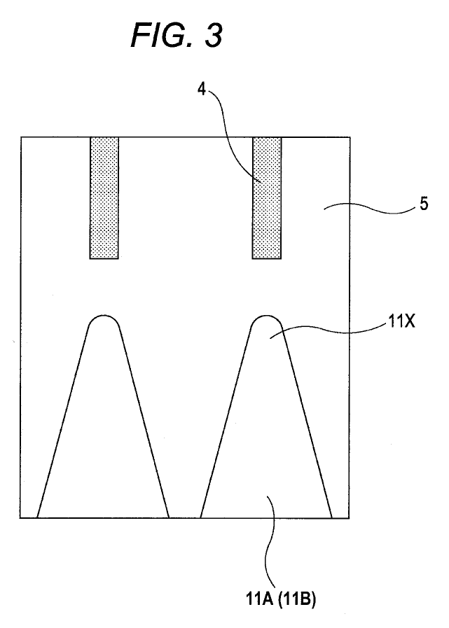

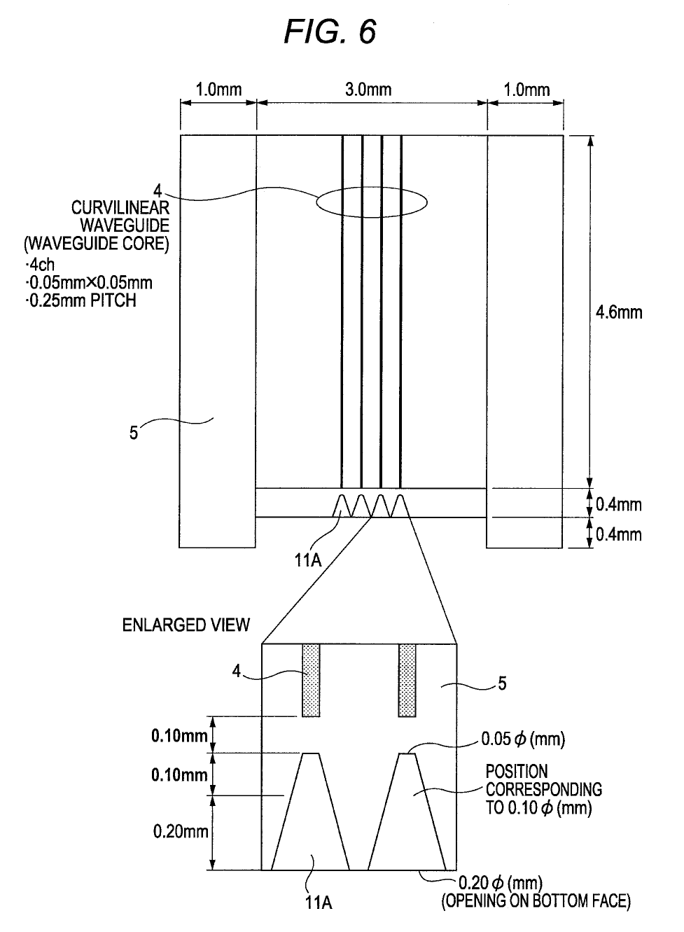

In the present example, the respective tapered openings 11A, 11B each are formed into a conical shape. However, the shape of the respective openings 11A, 11B is not limited to the conical shape. As an alternative example, the shape of the respective openings 11A, 11B may be a frusto-conical shape (see an enlarged view of FIG. 6). As another alternative example, as shown in FIG. 3, the configuration may be such that a deepest portion (bottom portion) 11X of the respective openings 11A, 11B is formed to function as a lens (condenser or collimate lens). Thus, with the deepest portion 11X of the opening 11A (11B) formed into the lens shape, the coupling efficiency can be improved. Further, the respective openings 11A, 11B are formed into the tapered shape in consideration of insertability of the optical resin pillars 10A, 10B, but it need not be formed into the tapered shape. The opening 11A is used for insertion of the optical resin pillar 10A formed on the PD 2A, and the opening 11B is used for insertion of the optical resin pillar 10B formed on the VCSEL 3A. The respective openings 11A and 11B may have the same diameter or may have different diameters. In the case the openings 11A and 11B are formed in different shapes, they may be formed into the shape corresponding to the cross-sectional area sizes of the optical resin pillars 10A and 10B.

As shown in FIG. 2, according to the present embodiment, the waveguide array 5, the PD array 2, and the VCSEL array 3 are mounted on the printed circuit board 1 in the manner that the edge face (where the openings 11A and 11B are formed) of the waveguide array 5 opposes the surfaces of the PD array 2 and the VCSEL array 3. The leading edges of the optical resin pillars 10A and 10B (respectively formed on the light receiving surfaces of the PDs 2A and the light emitting surfaces of the VCSELs 3A) are inserted into the openings 11A and 11B formed on the edge face of the waveguide array 5, and are optically coupled together.

Thus, as shown in FIG. 2, in the optical module, the inter-optical device coupling is implemented by use of the above-described method, which will be referred to hereinbelow as an optical path coupling method (optical coupling method). That is, the leading edges of the optical resin pillars 10A and 10B, which are formed on the optical devices (surface optical device arrays 2 and 3 (PD array and VCSEL array) on one side, are inserted into the openings formed in the optical device (waveguide array 5) on the other side, whereby alignment therebetween is facilitated. Further, even when a relative misalignment has been introduced therebetween, that is, between the devices on two sides due to deflection (flexibility) of the optical resin pillars 10A and 10B after mounting of the components, the misalignment can be absorbed and hence prevented.

In particular, according to the present embodiment, the waveguide array 5 is formed as the polymer optical waveguide structure formed of a transparent material (“first optical material” (in the appended claims); optically transmissive material; or resin material). In this case, at least a peripheral portion of the openings 11A, 11B of the waveguide array 5 (i.e., a portion between the edge face of the waveguide array 5 and the end portion of the respective optical waveguides 4) is formed of a transparent material (“second optical material” (in the appended claims); optically transmissive material; or resin material).

Further, as shown in FIG. 2, the interiors of the openings 11A, 11B formed in the waveguide array 5 are filled with a transparent material 12 (“third optical material” (in the appended claims); optically transmissive material; or resin material). Thereby, the leading edges of the optical resin pillars 10A and 10B are fixedly secured into the interiors of the openings 11A and 11B.

A refractive index of the transparent material (third optical material) 12, which fills up the interiors of the respective openings 11A, 11B, is higher than a refractive index of the transparent material (second optical material) constituting the waveguide array 5. Concurrently, the refractive index of the transparent material (third optical material) 12 is lower than a refractive index of the transparent material (first optical material) constituting the optical resin pillars 10A, 10B. Thereby, the respective deepest portion 11X can be caused to function as the lens, thereby enabling improving the coupling efficiency.

In the present example, the interiors of the respective openings 11A, 11B are thus filled with the transparent material 12. However, the configuration of the present invention is not limited thereby, and may be such that the leading edges of the optical resin pillars 10A, 10B are just inserted into the openings 11A, 11B, respectively.

A method of manufacturing the optical module of the present embodiment will now be described herebelow.

First, the waveguide array (“first optical device” in the appended claims) 5 including the plurality of curvilinear optical waveguides 4 and the pluralities of openings 11A and 11B on the surface of its own are preliminarily provided (see FIGS. 2 and 4).

In the present example, the respective tapered openings 11A, 11B, which are reduced in size toward the end portion of the optical waveguide 4 from the surface (the edge face opposing the printed circuit board 1 in the mounting event) is integrally formed on the extended line of the optical waveguide 4. In this manner, the waveguide array 5 is formed (see FIG. 2). The forming method for the openings 11A, 11B is not limited to the above, but, for example, the openings 11A, 11B may be formed after forming of the waveguide array 5.

Subsequently, optical resin pillars 10A and 10B (pillar-shaped elastic members (circularly columnar pillars in the present example)) are formed on the surfaces of the PD array 2 (second optical device (in the appended claims)) and the VCSEL array 3 (second optical device (in the appended claims)), respectively (see FIG. 2).

In the present example, the optical resin pillars 10A (circularly columnar pillars) are formed on the light receiving surfaces of the respective PDs 2A, which constitute the PD array 2 (see FIG. 2). The optical resin pillars 10B (circularly columnar pillars) are formed on the light emitting surfaces of the respective VCSELs 3A, which constitute the VCSEL array 3A. The optical resin pillars 10A, 10B can be formed by a photolithography process, for example. Other processes usable for forming the optical resin pillars 10A, 10B include, for example, a process described in “Integration of Optical Polymer Pillars Chip I/O Interconnections with Si MSM Photodetectors”, IEEE Transactions on Electron Devices, Vol. 51, No. 7, pp. 1084-1090, July 2004.

Subsequently, the PD array 2 and the VCSEL array 3, which include the plurality of optical resin pillars 10A and 10B, respectively, formed on the surface thereof, are fixedly secured and mounted on the printed circuit board 1 (see FIG. 2).

Then, the waveguide array 5 formed of the transparent material (second optical material) is disposed in an upper portion of the VCSEL array 3 and PD array 2. In the present example, the transparent material has a transmissivity, and the transparent material is made of a resin material. Subsequently, the edge face (edge face on which the opening 11A, 11B is formed) of the waveguide array 5 is positioned to oppose the light receiving surface of the PD 2A and the light emitting surface of the VCSEL 3A. In this state, the leading edges of the optical resin pillars 10A, 10B are inserted into the openings 11A, 11B to reach deep portions thereof, respectively. Thereby, the optical waveguide 4 of the waveguide array 5 is coupled to the respective VCSELs 3A and PDs 2A.

According to the present embodiment, the interiors of the respective openings 11A, 11B of the waveguide array 5 are preliminarily filled with the transparent material 12 (third optical material). Then, the transparent material 12 is cured after insertion of the leading edges of the optical resin pillars 10A, 10B, whereby the optical resin pillars 10A, 10B are fixedly secured into the interiors of the openings 11A, 11B, respectively. In the present example, the transparent material 12 is, for example, an optically transmissive material having transmissivity, and the transmissive material is made of a resin material. The coupling method between the optical resin pillars 10A, 10B and the openings 11A, 11B, respectively, is not limited to that described above, but the respective optical resin pillar 10A, 10B may just be inserted into the respective opening 11A, 11B.

After the above operation, the waveguide array 5 is fixedly mounted on the printed circuit board 1.

Thus, the inter-optical device coupling is implemented by use of the optical path coupling method (optical coupling method). That is, the leading edges of the optical resin pillars 10A and 10B formed on the optical device on one side (surface optical device arrays 2 and 3) are inserted into the respective openings 11A and 11B formed in the optical devices (waveguide array 5) on the other side. Thereby, the optical module is manufactured.

The optical module and the manufacturing method therefore in accordance with the present embodiment utilize self-alignment effects due to the deflection (flexibility) of the respective optical resin pillars 10A, 10B and the respective tapered openings 11A, 11B. This enables to produce an advantage of facilitating the inter-optical device alignment.

Further, even when misalignment has been caused by distortion introduced due to thermal expansion or the like after mounting of the components, such a problem is addressable by the deflection (flexibility) of the respective optical resin pillars 10A, 10B. Consequently, an advantage can be offered in that the performance of the optical module can be prevented from being unstabilized.

As described above, in the present embodiment, the optical module according to the present invention is exemplified by the multichannel optical tranceiver. However, the present invention is not limited in adaptability to such the tranceiver, but is widely adaptable to a large variety of optical modules for which optical devices have to be optically intercoupled. The optical module has the configuration that includes the waveguide array 5 including, for example, the curvilinear optical waveguides 4. However, the configuration is not limited to that described above, but may be formed as an optical module that includes, for example, linear waveguides.

### Other Embodiment

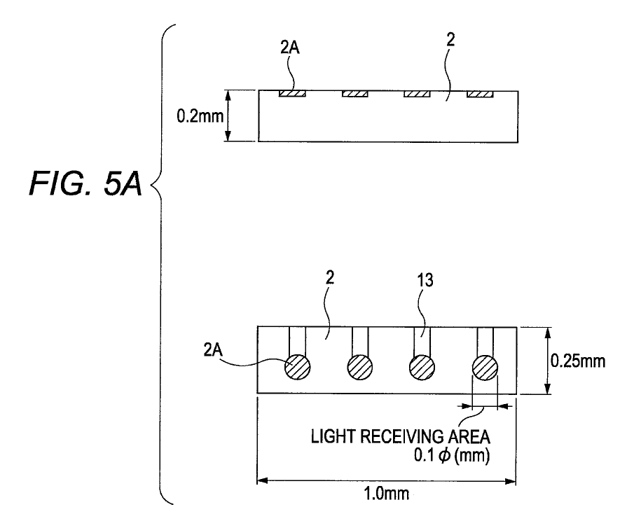

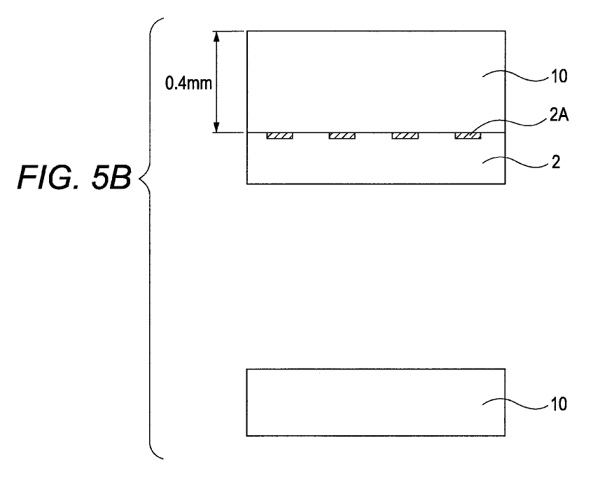

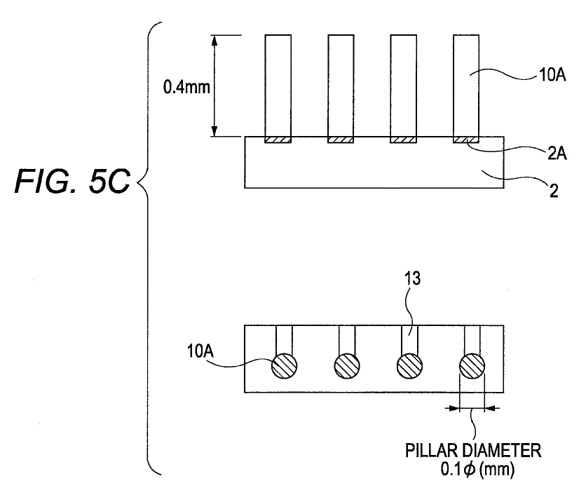

The present embodiment (Other embodiment) will be described herebelow with reference to FIGS. 5 to 7.

In the present embodiment, pillars 10A (pillar-shaped elastic members) were formed on a PD array 2, and are then inserted into openings 11A formed in a waveguide array 5 including four optical waveguides 4 and are optically coupled thereto. Thereby, the effectiveness of the configuration has been verified.

First, a GaAs 4-ch PD array (PD array 2 including four PDs 2A) for short wavelength (or, short wave) communication, as shown in FIG. 5A, was used as the PD array 2. The diameter of the light receiving surface of the PD 2A constituting the PD array 2 was 0.1 mm, and pitch between the PDs 2A was 0.25 mm. The dimensions of the outer profile of the PD array 2 are 1.0 mm (width)×0.25 mm (depth)×0.2 mm (thickness). In FIG. 5A, reference numeral 13 denotes an electrode.

As shown in FIG. 5C, polymer pillars (optical resin pillars; pillar-shaped elastic members) 10A each having a diameter of 0.1 mm and a length of 0.4 mm were formed by the photolithography process on the light receiving surfaces (light receiving areas) of the respective PDs 2A constituting the PD array 2.

First, as shown in FIG. 5B, a norbornen-based UV polymer (pillar-dedicated resist; first optical material; transparent resin material) 10 was coated by a spin coating process to a thickness of 0.4 mm on the surface of the PD array 2. Then, as shown in FIGS. 5B and 5C, UV exposure and patterning were performed using a mask, and other portions were removed so that four circular columns or pillars each having a diameter of 0.1 mm remained. Thereby, totally four polymer pillars 10A were formed on the surface of the PD array 2. In this case, the refraction index of the norbornen resin for forming the pillar 10A was 1.58.

The waveguide array 5 was formed in a manner described hereinbelow by using the 4-channel waveguide array including the four optical waveguides 4 as shown in FIG. 6.

First, using an olefin resin (second optical material; optically transmissive (resin) material) as a base, a transparent curved structure (clad structure) including four grooves along the curved surface and four openings 11A on the edge face (edge face opposing the substrate in the mounting event) were formed by an injection molding process. Then, a UV-curing epoxy resin (UV: ultraviolet) having a high refractive index higher than the olefin resin (core liquid) was made to fill the respective four grooves, a clad film was bonded to the epoxy resin, and a UV ray was irradiated to thereby cure the epoxy resin. Thereby, the waveguide array 5 was formed. The refractive index of the olefin resin for forming the waveguide array 5 was 1.52, and the refractive index of an epoxy resin for forming respective waveguide cores was 1.55.

In the present embodiment, the outer size of the waveguide array 5 was determined to the dimensions shown in FIG. 6. Further, the size of the respective waveguide core (respective groove) was determined as 0.05 mm (vertical length)×0.05 mm (horizontal length), and inter-waveguide core (inter-groove) pitch was determined to 0.25 mm.

Further, as shown in an enlarged view in FIG. 6, openings 11A(tapered openings) were formed on the edge face (edge face opposing the substrate in the mounting event) of the waveguide array 5. More specifically, the respective tapered opening was formed such that the diameter thereof was gradually increased towards the edge face (bottom wall) of the waveguide array 5 from a position spaced apart by 10 mm from the end portion of the respective optical waveguide 4. In the present embodiment, the length of the tapered opening was 0.30 mm, and the diameter of the opening was gradually increased from 0.05 mm to 0.20 mm.

An assembly process was performed in a manner described hereinbelow.

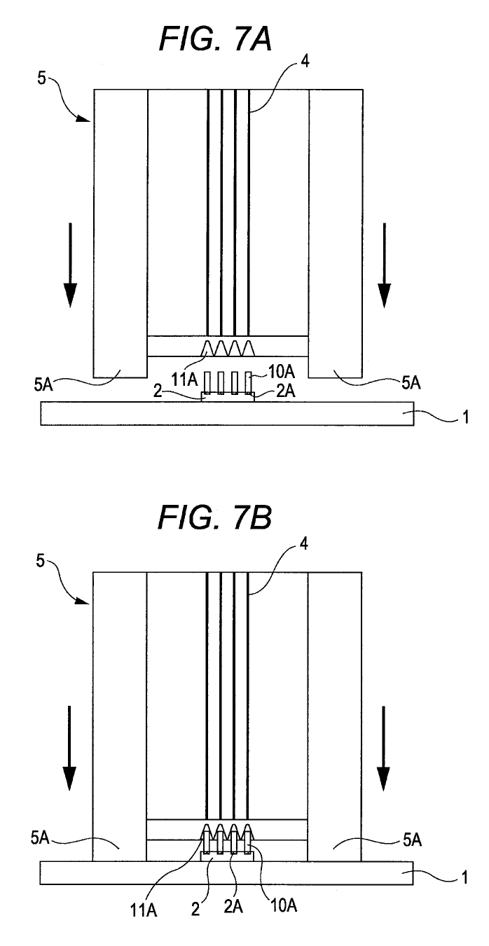

First, with reference to FIG. 7A, the PD array 2 with the pillars 11A was directed upward and was fixedly secured with an adhesive onto the printed circuit board 1 including thereon electrical wirelines. Thereby, electrodes 13 of the PD array 2 and the electrical wirelines of the board 1 were coupled to each other with wirebonding.

Then, with reference to FIGS. 7A and 7B, the waveguide array 5 is moved to an upper portion of the PD array 2, and alignment was performed so that the four pillars 10A were inserted into the four tapered openings 11A. Then, the waveguide array 5 was moved downward, and spacer portions 5A of the waveguide array 5 were fixedly secured with an adhesive onto the board 1.

By use of five samples (prototypes) thus manufactured, evaluation was made for coupling losses between the respective optical waveguides 4 and PDs 2A. More specifically, the evaluation was made in such a manner that a laser beam of an 850 nm wavelength was incident on the respective optical waveguides 4 of the waveguide array 5.

The evaluation was made for the total of 20 coupled portions between the respective optical waveguides 4 and PDs 2A of the five samples. The evaluation results showed that the coupling losses in all of these portions were within a range of from 1.0 dB to 1.5 dB. Further, while the temperature was increased up to 80° C., substantially no variation was observed. Thereby, verification was able to be made that the performance is prevented from being unstabilized even when the temperature was increased and hence misalignment could be increased by thermal expansion or the like between the optical devices.

### Furthermore Other Embodiment

In the present embodiment, similarly as in the case of above embodiment(Other embodiment), the PD array 2 with the pillars 10A and the waveguide array 5 were preliminarily provided.

In the assembly process, a liquid epoxy resin 12 (third optical material; optically transmissive (transparent) resin material), which was the same as the epoxy resin used as the core liquid, was made to fill the tapered openings 11A of the waveguide array 5. Then, the resin material was cured and fixedly secured after the insertion of the pillars 10A.

In the present embodiment, synchronously with the curing of an optical adhesive used to fixedly secure the waveguide array 5 and the PD array 2 onto the printed circuit board 1, the epoxy resin filling the tapered openings 11A was cured. Thereby, the pillars 10A were fixedly secured to the respective tapered openings 11A synchronously with fixedly securing of the waveguide array 5 and the PD array 2 onto the printed circuit board 1.

Similarly as in the case of above embodiment(Other embodiment), by use of five samples (prototypes) thus manufactured, evaluation was made for coupling losses between the respective optical waveguides 4 and PDs 2A. More specifically, the evaluation was made in such a manner that a laser beam (LED beam) of an 850 nm wavelength was incident on the respective optical waveguides 4 of the waveguide array 5.

The evaluation was made for the total of 20 coupled portions between the respective optical waveguides 4 and PDs 2A of the five samples. The evaluation results showed that the coupling losses in all of these portions were within a range of from 0.4 dB to 0.9 dB. Further, while the temperature was increased up to 80° C., substantially no variation was observed. Thereby, verification was able to be made that the performance was prevented from being unstabilized even when the temperature was increased and hence misalignment could be increased by thermal expansion or the like between the optical devices.

According to the optical module and manufacturing method therefor in each of embodiments, advantages can be obtained in that the inter-optical device alignment can be facilitated, and the performance can be prevented from being unstabilized even when the temperature is increased and hence misalignment can be increased by thermal expansion or the like.

Further, the present invention is not limited to the embodiments described above, but can be altered or modified in various ways without departing the spirit and scope of the invention.

What is claimed is:

1. An optical module comprising:
a first optical device including an opening on a surface thereof; and
a second optical device including a pillar-shaped elastic member on a surface thereof,
wherein the first and second optical devices are optically coupled to each other in a state where a leading edge of the pillar-shaped elastic member is inserted into the opening.

2. An optical module according to claim 1, wherein the first optical device is an optical waveguide device including the opening on an extended line of the optical waveguide.

3. An optical module according to claim 1, wherein the pillar-shaped elastic member is arranged on a light receiving surface of the second optical device.

4. An optical module according to claim 1, wherein the pillar-shaped elastic member is arranged on a light emitting surface of the second optical device.

5. An optical module according to claim 1, wherein the opening is an opening having a tapered shape, and the opening is reduced in diameter towards a depth thereof.

6. An optical module according to claim 1, wherein the opening has an arcuate shape in a deepest portion thereof.

7. An optical module according to claim 1, wherein
the pillar-shaped elastic member is formed of a first optical material,
in the first optical device, a peripheral portion of the opening is formed of a second optical material,
the opening has an interior filled with a third optical material, and
a refractive index of the third optical material is higher than a refractive index of the second optical material and is lower than a refractive index of the first optical material.

8. A method of manufacturing an optical module, comprising:
preliminarily providing a first optical device including an opening on a surface thereof;
forming a pillar-shaped elastic member on a surface of a second optical device; and
inserting a leading edge of the pillar-shaped elastic member into the opening to optically couple the first and second optical devices to each other in a state where the first optical device is made to oppose the second optical device.

9. A method according to claim 8, wherein the first optical device is an optical waveguide device including an optical waveguide on an extended line of the opening, and the optical waveguide device is integrally formed.

10. A method according to claim 8, further comprising filling an interior of the opening with an optical material after inserting the leading edge of the pillar-shaped elastic member into the opening.
